(19) United States
(12) Patent Application Publication
(10) Pub. No.: US 2017/0370193 A1
(43) Pub. Date: Dec. 28, 2017

(54) SYSTEM FOR DETERMINING FORMATION STRESSES USING DRILL CUTTINGS

(71) Applicant: Trican Well Service, Ltd., Calgary (CA)

(72) Inventors: Kenneth Glover, Canmore (CA); Troy Bozarth, Calgary (CA); Albert Cui, Calgary (CA)

(73) Assignee: Trican Well Service, Ltd., Calgary (CA)

(21) Appl. No.: 15/634,325

(22) Filed: Jun. 27, 2017

Related U.S. Application Data
(60) Provisional application No. 62/354,835, filed on Jun. 27, 2016.

(51) Int. Cl. E21B 43/119; C09K 8/03; G01N 3/40; G06F 17/10

(52) U.S. Cl. CPC E21B 43/119; G01N 3/40; C09K 8/032; G06F 17/10

(57) ABSTRACT

Utilizing multiple rock cores samples obtained while drilling a well to determine the mechanical properties of the rock constituting the wellbore and formation zones within the wellbore. A geomechanical model is created from the samples by nanoindentation testing to provide the raw data from which the geomechanical model is then created.

### CROSS-REFERENCE TO RELATED APPLICATIONS

This application claims priority to U.S. Provisional Patent Application No. 62/354,835 that was filed on Jun. 27, 2016.

### BACKGROUND

It has been found that understanding the complex properties of the rocks through which a wellbore is being cut, including the rocks of the formation through which the wellbore passes, is of use in optimizing the drilling, completing, and producing of the well.

The placement of hydraulic fracture stages along a wellbore may be determined at least in part by understanding the rock mechanics within which the different hydrocarbon bearing formations exist and to which the drill bit must pass as it cuts the wellbore. When data is available a properly utilized geomechanical well profile increases the likelihood that artificial fractures will be initiated at the point along the wellbore and within a formation to maximize fracture growth as well as production through that fracture.

### SUMMARY

The invention relates to a method of determining the physical characteristics of the rock in the wellbore, such as permeability, elasticity, breakdown pressure, over balance pressure, and pore pressure.

One solution to optimize the understanding of the physical characteristics of the rock in the wellbore is to acquire rock cuttings that have been returned to the surface by the drilling fluid as the drill bit cuts the wellbore and penetrates the formations. It is necessary to determine approximately correlate the rock cuttings to the position within the wellbore from which the cuttings are removed. However, it is notable that there is some time lag associated with the rock cuttings being removed by the drill bit and the cutting samples being returned to the surface via the wellbore fluid.

Typically, in order to determine the physical characteristics of the rock it is necessary to begin with a plurality of cuttings. The cuttings are mounted in an epoxy cylinder where the rock cuttings are placed into a form, such as a cylinder, and then an epoxy is added to fill the voids within the cylinder. Once cured, the cylinder is cut, usually into sample slices, in order to expose sections of the rock. Each selected sample slice is then polished.

Generally, the epoxy is selected to reasonably match the hardness and or stiffness of the rock cuttings. For example, if the rock is soft the epoxy should be soft and if the rock is very hard epoxy should be very hard. The object is to generally match, at least within an order of magnitude, the rock's resistance to indentation in order to prevent the epoxy from flexing while testing the rock within the epoxy.

The rock cuttings that are used to create the sample slices typically represent an interval of a well and not a discreet location within the well. This is due to such facts as, as the drill bit cuts through the rock the drill bit is changing locations within the wellbore, it takes time for the fluid to bring the cuttings to the surface, and the fluid is not 100% efficient therefore the fluid may mix cuttings from various areas within the wellbore. Utilizing multiple samples from each particular interval accounts for the variability of the particular interval within a well.

Once a sample is prepared the sample is placed within the nanoindentometer. Generally, the nanoindentometer is a computer controlled, nano-mechanical tester. The most common type uses a video microscope to watch the indenter as the indenter approaches the surface of the sample. The nanoindentometer typically measures the load through the probe or indenter.

The validation process from which the mechanical properties of the rock sample are calculated takes into account the edge or boundary values of the rock within each sample. By understanding the edge or boundary effects of the rock cuttings within each sample the stress distribution throughout the rock cutting may be determined.

In one method of determining the edge or boundary values of the rock cutting within a sample, a number of nano-indentations are performed in a grid pattern over the surface of the cutting sample. A numerical model is used to simulate the indentation process and calculate the stress distribution and the properties of the two components of the system. A determination is then made based upon the results of each nano-indentation test, as to what represents rock and what represents the epoxy.

A second method of determining the edge or boundary values of the rock cutting sample is to visually determine when the probe is testing either rock or epoxy.

Current computer-controlled nanoindentometers are able to obtain a sufficiently fine resolution allowing both the elastic and plastic properties of the rock cuttings to be determined. Additionally, the precise control obtainable allows the measurement of time-dependent properties where a load is applied and held by the indenter. The load is then watched as the load slowly dissipates as the rock absorbs the pressure. Generally, the rock properties such as elasticity, plasticity, and viscosity are time-dependent.

### BRIEF DESCRIPTION OF THE DRAWINGS

FIG. 1 depicts an example of the images and force-displacement curve obtained from an indentation test.

FIG. 2 depicts force-displacement curves obtained from one multiple indentation tests.

FIG. 3 depicts the surface roughness evaluation of a 1 inch diameter core plug after a standard surface grinding preparation.

FIG. 4 depicts a 3×3 indentation grid on the surface of a surface grinder polished core plug.

FIG. 5 depicts the load-hold-unload curves of load versus depth that correspond to the 3×3 arrays in FIG. 4.

FIG. 6 depicts the data analysis of each of the load-hold-unload curves from FIG. 5.

FIG. 7 depicts a line of indentation tests run across the rock sample from the Wolf Camp formation.

FIG. 8 depicts an indentation test grid having a series of indentations, where each line of indentations have various spacing.

FIG. 9 depicts an evaluation of in situ stress for a single zone from samples collected in the Eagleford.

FIG. 10 depicts the relationship between rock anisotropy and breakdown pressure.

FIG. 11 depicts a profile of Young's modulus data obtained from drill cuttings along a section of a well in addition to a calculated breakdown pressure profile.

### DETAILED DESCRIPTION

The description that follows includes exemplary apparatus, methods, techniques, or instruction sequences that embody techniques of the inventive subject matter. However, it is understood that the described embodiments may be practiced without these specific details.

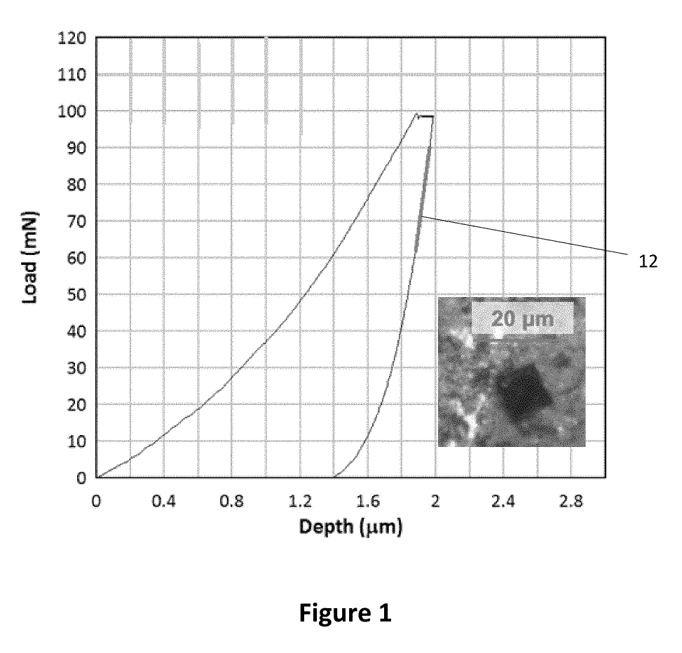

In an embodiment of the invention an optical microscope is used to select locations in the sample that are suitable for testing. Indentations are made on the prepared sample surface under programmed force-displacement control. Continuous measurements of force and displacement are made during a series of loading, loading-holding, and unloading stages. Digital images from both before and after indentation are utilized to aid in data analysis and data reduction. FIG. 1 depicts an example of the images and force-displacement curve obtained from one such indentation test.

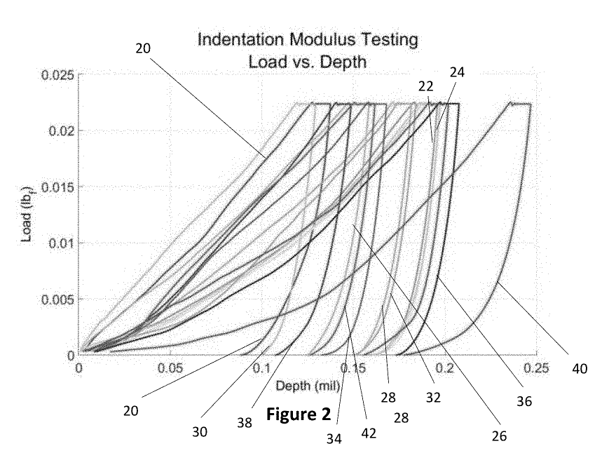

FIG. 2 depicts multiple tests, each giving an indentation force displacement curve obtained from a single cutting sample chip. The indentation data and unloading curve in FIG. 1 can be analyzed as follows:

$$H = \frac{{P}_{Ma x}}{{A}_{c}}$$

Where H is the sample hardness, P_{Max} is the maximum indentation load, and A_{c} is the contact area under the indenter at peak load. The elastic modulus of the sample is found by analyzing the unloading curve as follows:

$${E}_{app} = \frac{dP}{dh} ( \frac{\sqrt{π}}{2 \sqrt{{A}_{c}}} ) = {( \frac{1 + {v}^{2}}{E} + \frac{1 - {v}_{i}^{2}}{{E}_{i}} )}^{- 1}$$

Where Eₐₚₚ is the apparent modulus of the sample, dP/dh is the slope of the unloading curve 12, v is Poisson's ratio, E is the sample Young's modulus, vᵢ is the Poisson's ratio of the indenter tip, and Eᵢ is the Young's modulus of the indenter tip. The testing process is repeated numerous times across the sample surface producing an array of load-hold-unload curves and a corresponding distribution of mechanical property data as is shown in FIG. 2.

In FIG. 2, test 1 is shown as reference numeral 20. Test 2 is shown as reference numeral 22. Test 5 is shown as reference numeral 24. Test 6 is shown as reference numeral 26. Test 7 is shown as reference numeral 28. Test 8 is shown as reference numeral 30. Test 9 is shown as reference numeral 32. Test 10 is shown as reference numeral 34. Test 13 is shown as reference numeral 36. Test 14 is shown as reference numeral 38. Test 15 is shown as reference numeral 40. Test 16 is shown as reference numeral 42.

The force displacement curves in FIG. 2 allows analysis of the contributions of individual measurements to the property of the larger sample by considering the overall sample as a composite material. Generally the indentation measurement scale is at least one order of magnitude larger than the individual fabric elements of the composite rock material.

Generally, the most accurate surface preparation of a sample is accomplished by ion beam milling. However, ion beam milling preparations add hours per sample to the preparation time of each sample making it difficult to gain useful data in a real time drilling operation. Therefore, it was determined that there is a need to reduce the testing and analysis time involved so that the data could be used during drilling and in the completions design decision process after drilling.

The initial surface preparation of the samples used a dry 0.05 μm mechanical polisher rather than ion beam milling. The dry mechanical polishing method provided a surface smoothness (0.05 μm) whereas given the particular sample utilized experienced indentation depths of between 2 and 4 μm.

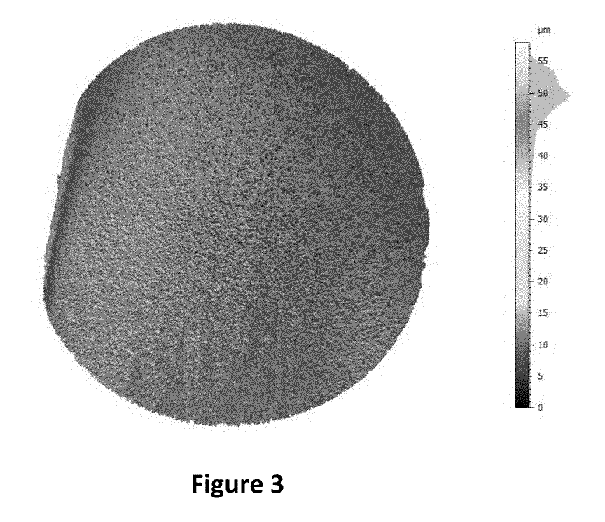

The surface roughness of a 1 inch diameter plug-end following surface grinding was measured using an optical profileometer and data was analyzed for surface roughness qualification. The analysis showed an approximately normal distribution of surface elevations with a range of about 10 μm as is shown in FIG. 3. Where FIG. 3 depicts the surface roughness evaluation of a 1 inch diameter core plug, drilled parallel to bedding, after a standard surface grinding preparation. The area of interest is depicted according to surface topography and has a surface roughness range of 10 μm as indicated by the histogram alongside the scale bar.

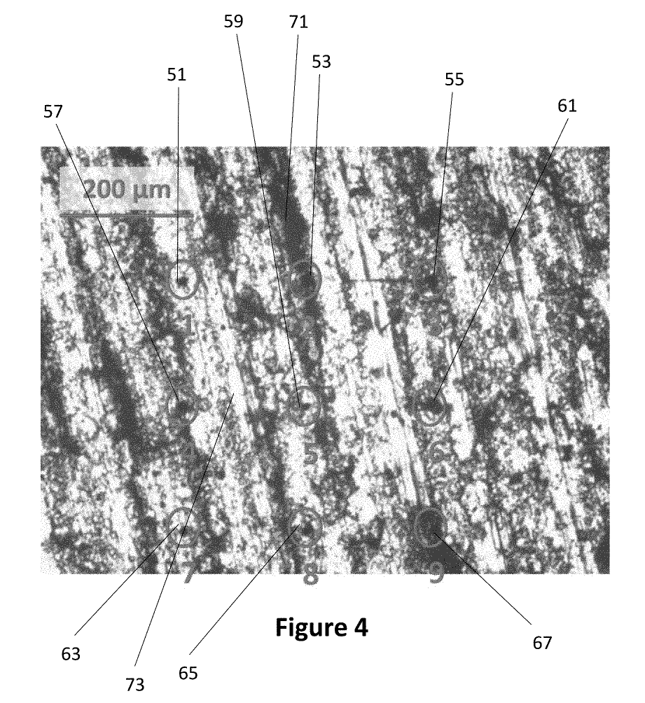

In FIG. 4 the roughness of the polished surface appears to be due to a combination of the scratch lineation's created by the surface grinding wheel, layered mechanical heterogeneity, and variations of sample material from discrete locations. A sample array of 3×3 instrumented indentations, where each indentation is separated by 200 μm in both the X and Y axes from the next adjacent indentation, was performed over the surface of the sample plug. The indentations 51, 53, 55, 57, 59, 61, 63, 65, and 67 are shown within the topography of the plug surface.

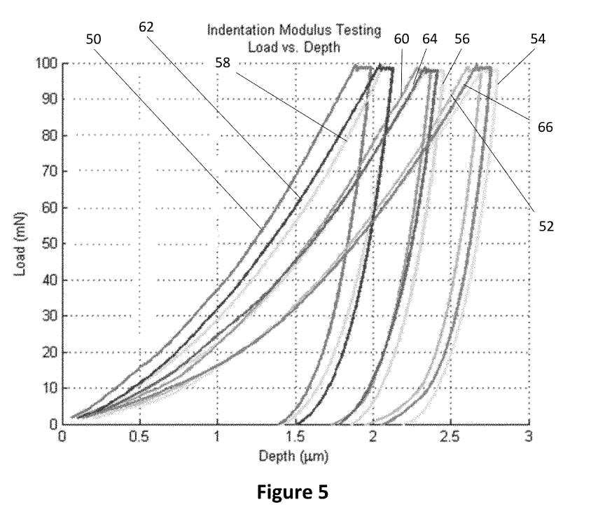

FIG. 5 depicts the load-hold-unload curves of load versus depth that correspond to the 3×3 arrays shown in FIG. 4. The curves with the greatest depth of indent as depicted by curves 52, 54, and 66 correspond to the location of indents 53, 55, and 67 which were created in the darker striations, such as striations 71, shown in FIG. 4. Conversely the curves with the least depth of indent as depicted by curves 50, 58, and 62 corresponds to the location of indents 51, 57, and 63 which were created in the lighter striations, such as striations 73, from FIG. 4.

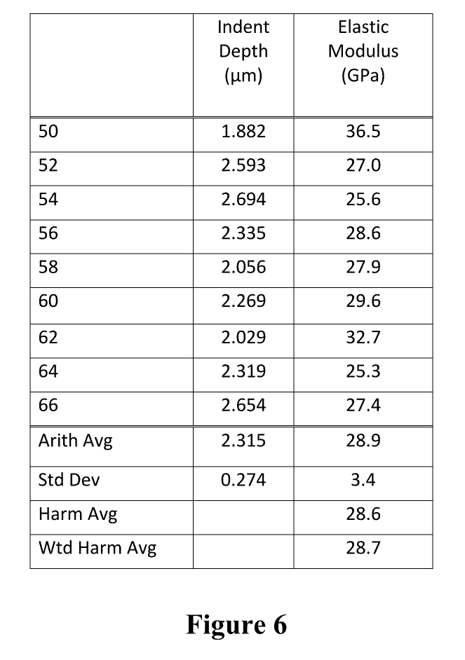

The data analysis of each of the load-hold-unload curves, as shown by each curve's respective reference numeral 50, 52, 54, 56, 58, 60, 62, 64, and 66 from FIG. 5, are shown in FIG. 6. As can be seen in FIG. 6 generally a higher modulus was measured in the lighter striations depicted by curves 50, 58, and 62.

In another series of tests, it was seen that the scale of heterogeneity present in rocks can potentially be very wide. A series of indentation measurements were conducted on various rock bases with known fabric using core from producing areas of the Eagleford formation in South Texas, the Wolf Camp formation of the Permian basin, and the Montney Formation of northeastern British Columbia, Canada. All core tests in the study were performed at mean effective stress confinement conditions unless stated otherwise.

The faces with the greatest heterogeneity, in terms of size scale of its fabric, was a bioclastic mudstone with bituminous laminae from the WolfCamp Formation. Core plugs from these bases were tested for elastic mechanical properties, with plug end-cuts prepared for indentation testing and pictographic analysis. Parallel test lines of indentations were run across plug end-cuts with different spacings between the indentation points.

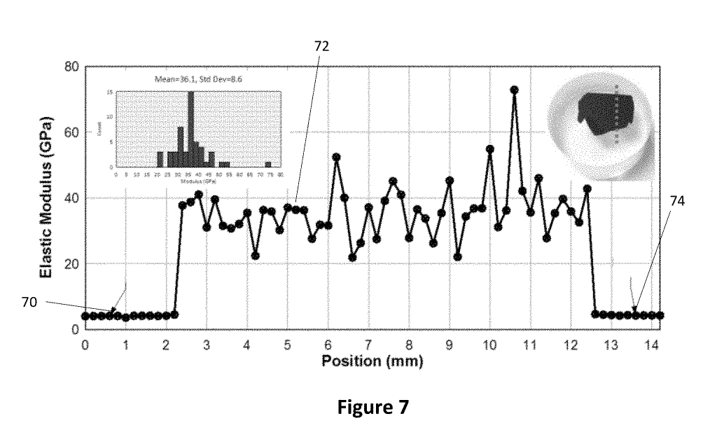

FIG. 7 depicts a line of indentation tests run across the rock sample from the Wolf Camp formation. Indentation spacing 0.20 mm from center to center of indentation points for the indentation begins in an epoxy section 70 crosses over to a rock section 72 and then back into an epoxy section 74. Additional test lines were run across the sample used for the tests in FIG. 7 to compare the effect of indentation spacing on the distribution of data that is obtained. Each indentation, after unloading, leaves a residual imprint that is approximately 20 μm across. A majority of the indentation tests measured an elastic response similar to the static Young's modulus measured in the core plug, with a few data outliers representing measurement of porous organic matter or re-crystallized bioclasts.

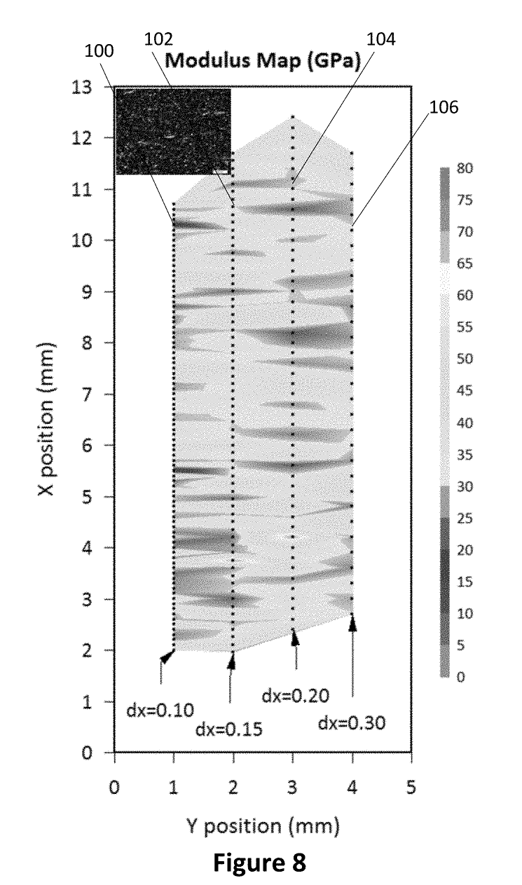

FIG. 8 is an indentation test grid having a first series of indentations 100 where each indentation is spaced apart by 0.1 mm, a second series of indentations 102 where each indentation is spaced apart by 0.15 mm, a third series of indentations 104 where each indentation is spaced apart by 0.2 mm, and a fourth series of indentations 106 where each indentation is spaced apart by 0.3 mm. The indentation series 104 was shown previously in FIG. 7. The Young's modulus data was contoured linearly between measurement points in grayscale with the scale 108 positioned to the right.

For this particular lighological facies it was determined that the reliability of mechanical characterization by indentation testing was relatively insensitive to the spacing between indentation tests. A spacing of 0.1 mm can be considered a lower limit of recommended spacing given the 0.02 mm residual indent cross-sectional distance after unloading. Under similar conditions closer spaced indents would be at risk of having overlapping regions of plastic strain.

An upper limit to the spacing between indentations is then imposed by the size of the drill cuttings and the corresponding number of indentations that can be performed across a given drill cutting. The upper limit to the spacing between indentations may be several millimeters.

An embodiment of the current invention obtains rock mechanical property data from drill cuttings where the rock mechanical property data is of sufficient resolution to analyze the fracture initiation and perforation efficiency of the formation. In this embodiment, one-dimensional geomechanical models of horizontal wellbores are constructed from data obtained from drill cuttings. Typically, the data has been calibrated to a core plug measurement from the vertical section of the well or the core plug measurement of another well in the same well pad. Data calibration is generally on an empirical basis with core plug tests being considered the “ground truth” data. The calibrated models are then used to predict the lateral variability of fracturing parameters along the wellbore.

Analytical methods of predicting tensile fracture initiation at a borehole wall due to increased wellbore pressure are useful for analyzing the breakdown pressure problem for horizontal open hole completions. The driving factor in fracture initiation is the magnitude of tangential stress which must be overcome by pressuring a section of the wellbore. Expressions for the tangential stress component of the breakdown criteria take the form of the equation:

σ′_{θ}=Aσ′_{θ,A}+Bσ′_{θ,B}+Cσ′_{θ,pw}

This expression accounts for the influence of rock anisotropy on the variation of tangential stress with angular position by introducing the coefficients A, B, and C. In the case of anisotropic rock mechanical properties these coefficients are functions of the rock stiffness matrix components and replace the 3, −1, and −1 of the Kirsch solution for stresses at a wellbore wall. The Kirsch solution is:

σ′_{θ(0,180)}=3σ′_{horiz}−1σ′ᵥₑᵣₜ−Δp_{w}

Where, Δp_{w} refers to the over balance pressure in the wellbore, and where subscripts “zero” and “180” refer to locations at the top and bottom of the wellbore wall respectively. For a low viscosity water-based fluid system and rock with permeability less than about 0.001 mD, or with perfect mud caked pressure isolation, the problem can be analyzed with the static mechanical analysis. To initiate a tensile fracture and isolated section of the wellbore must be pressurized such that the tangential stress is reduced to below the tensile strength of the rock. For transversely isotropic rock this over balance condition is described as:

$$Δ {p}_{w - break} = ( \frac{- {T}_{0} - A {σ}_{horiz}^{′} - B {σ}_{vert}^{′}}{C} )$$

Again A, B, and C are functions of angular position around the wellbore and of the components of the rock elastic stiffness matrix. For vertical transverse isotropic rock fabric A, B, and C may be determined by:

A,B,C=f(Eᵥ,Eₕ,vᵥ,vₕ,Gᵥₕ)

Generally each of these 5 elastic properties are characterized using core plug data. Indentation measurements are made to obtain elastic moduli in bedding-parallel in bedding-perpendicular directions as previously described. Values of Eᵥ and Eₕ are then used to calculate an approximate Gᵥₕ by invoking St. Venant's principal whereby shear stress concentration near a load boundary can be ignored when evaluating the stress state away from the load boundary such that:

$${G}_{vh} = \frac{{E}_{v} {E}_{h}}{{E}_{h} + {E}_{h} + 2 {v}_{vh} {E}_{v}}$$

This approach provides a good first-order approximation of shear modulus in the plane of isotropy from elastic properties measured parallel and perpendicular to the plane of isotropy.

The anisotropic rock model response of the wellbore wall to far field stresses and to wellbore pressure is influenced by the elastic properties of the rock. In particular for VTI anisotropic rock, tangential stress at the wellbore wall is partitioned by the rock fabric. The magnitude of the stress partitioning is proportional to the ratio of horizontal to vertical Young's modulus, Eh:Ev. This approximation provides a convenient way to use indentation measurements to calculate stress partitioning of VTI rock fabric around a borehole.

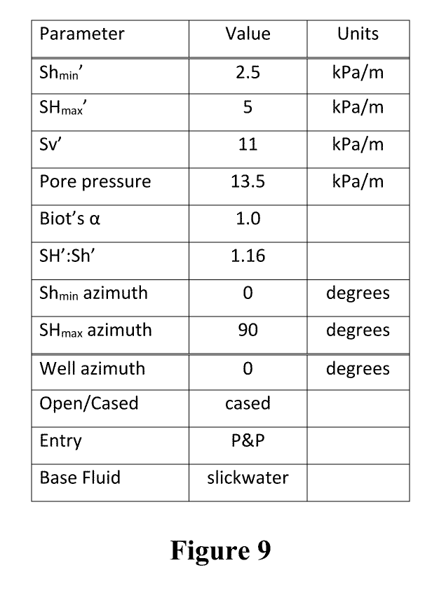

In another test, cutting samples were collected during the drilling of four wells in the Eagleford of South Texas. Samples were collected every 5 to 10 m while drilling and were evaluated following the procedures described previously. Rock mechanical property data from the cuttings were calibrated to core data in the vertical sections of two wells. An evaluation of in situ stress for a single zone from the samples collected in the Eagleford is shown in FIG. 9.

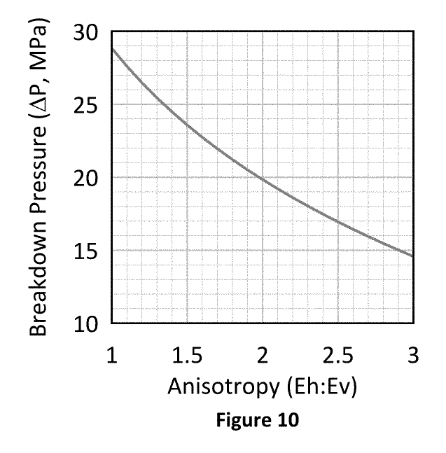

For an anisotropic rock form of the near wellbore stress equations it is assumed that the principal stress conditions are constant. Therefore, changes in hoop stress along the well and thus changes in the breakdown pressure along well are primarily a function of rock property anisotropy and its effect on the partitioning of tangential stress. For the 1D model parameters given in FIG. 9 the impact of rock anisotropy on breakdown pressure follow the relationship shown in FIG. 10 where fracture initiation is favored at the top and bottom of the wellbore and increased stiffness in the horizontal plane further reduces the breakdown pressure requirement.

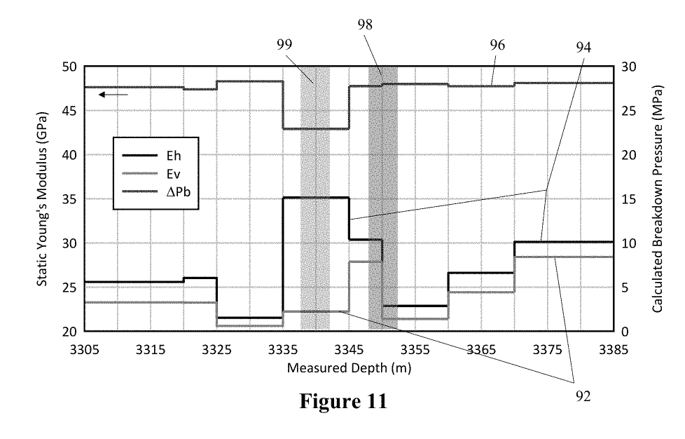

A section of a simple 1D model, from FIG. 9, with breakdown pressure calculation is shown in FIG. 11 where the far field stresses and pore pressures are held constant throughout the well in order to demonstrate the role of rock properties in this process.

FIG. 11 depicts a profile of Young's modulus data obtained from drill cuttings along a section of a well in addition to a calculated breakdown pressure profile. Young's modulus in the vertical plane, Eᵥ, is shown as reference numeral 92, Young's modulus in the horizontal plane, Eₕ, is shown as reference numeral 94, and the breakdown pressure is shown as reference numeral 96. In this example, the far field stresses and pore pressures are held constant throughout the well in order to demonstrate the role of rock properties in this process. Breakdown pressure is the over balance required downhole to initiate a tensile fracture. In this instance consistency and breakdown pressure could be achieved within a given stage by moving the stage from stripe 98 to stripe 99.

In FIG. 11 each stair step represents an interval where drill cuttings were obtained and their indentation modulus measured. In this particular 80 m section of the well there are nine discrete intervals over which cuttings were obtained and measured. Each sample interval requires multiple cutting chips to be analyzed with dozens of measurements made on each chip.

By moving the stage and perforation locations by 10 m as indicated by moving the stage from stripe 98 to stripe 99 the likelihood of each perforation performing as designed increases due to the rock within each stage having relatively uniform mechanical qualities. The relatively uniform mechanical qualities increases the likelihood of evenly distributed open perforation's across the stage enhancing the ability to place the fluid and proppant as desired.

In the event that potential breakdown pressure reductions in the range of 5 MPa is less important than ensuring even distribution of contravening perforations at each stage a more effective measure would be to avoid the stage indicated by stripe 99.

The methods and materials described as being used in a particular embodiment may be used in any other embodiment. While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of wellbore modeling comprising:
obtaining at least two rock samples from a wellbore;
mounting the rock samples in an epoxy;
dividing the rock samples into at least two sample chips;
testing the sample chips;
wherein the sample chips are tested by nanoindentation to obtain the raw data;
subjecting the raw data to analytical methods to determine a Young's modulus in the vertical and horizontal planes;
subjecting the raw data to analytical methods to determine a breakdown pressure for a zone within a well;
determining a perforation zone based upon the breakdown pressure of the zone within the well.
